(19) United States
(12) Patent Application Publication
(10) Pub. No.: US 2005/0075976 A1
(43) Pub. Date: Apr. 7, 2005

(54) Enhanced premium equity participating securities

(76) Inventors: Kevin G. Woodruff, New York, NY (US); Serkan Savasoglu, New York, NY (US); Nathan N. McMurtray, New York, NY (US)

Correspondence Address: KIRKPATRICK & LOCKHART NICHOLSON GRAHAM LLP, 535 SMITHFIELD STREET, PITTSBURGH, PA, 15222, US

(21) Appl. No.: 10/679,054

(22) Filed: Oct. 3, 2003

(51) Int. Cl. G06F 17/60

(52) U.S. Cl. 705/40; 705/35

(57) ABSTRACT

A financial unit is disclosed. According to one embodiment the unit includes a fixed income security and a forward purchase contract. The fixed income security may include a maturity date, a principal amount and an interest amount. The forward purchase contract may obligate a holder of the forward purchase contract to purchase a quantity of equity securities of an issuer of the unit for a price equal to the stated amount of the unit no later than a settlement date specified in the forward purchase contract. In addition, the forward purchase contract may further obligate the issuer of the unit to pay a purchaser of the unit a forward purchase contract payment at issuance of the unit and possibly additional forward contract payments after issuance.

### BACKGROUND OF THE INVENTION

The present invention relates generally to investment instruments and, more particularly, to systems and techniques for enhancing the tax treatment of a specific type of investment security—tax-deductible unit structured mandatory convertible securities.

Firms have traditionally issued conventional securities such as straight debt and common stock in order to raise capital. In general, straight debt securities (e.g., bonds, notes, loans, mortgages) raise capital by borrowing and promising to repay a principal amount and interest on a specified future date(s). Common stock securities, on the other hand, raise capital by selling an equity interest in the firm.

In addition to conventional types of securities, firms also have a variety of more sophisticated hybrid investment instruments at their disposal. These hybrid securities often combine attributes of several different types of securities (e.g., debt components and equity components) and may change optionally or automatically at certain points in time or depending on market conditions. Convertible securities, such as convertible debt, for instance, provide the issuer and/or the holder with the option of exchanging the convertible securities for other related securities, such as common stock. Convertible securities may be priced at a premium, yet may be attractive to investors due to the mix of features, for example, earning interest like bonds when the stock price is down or flat and increasing in value like common stock when the stock price rises.

Mandatory convertible securities are a type of hybrid that automatically converts from debt into common stock on a specified future date. Mandatory convertible securities typically pay interest like a debt security until conversion and can have a variety of payoff structures that determine the number of shares of common stock ultimately provided to the holder. Typically, the number of shares will depend on the market price of the stock over an averaging period shortly before the conversion date relative to certain threshold prices.

A relatively recent innovation has been to structure mandatory convertible securities as units, which include a fixed income security (such as a note) and a forward purchase contract. The fixed income security provides ongoing interest payments from the issuer to the holder until maturity and repayment of its principal amount when it matures. The forward purchase contract is an agreement requiring the holder to buy a quantity of common stock from an issuer for a given price on or before a certain settlement date. The number of shares to be purchased is determined by a payoff function that generally depends on the market price of the common stock over a measuring period shortly before the settlement date relative to specified threshold prices. The threshold prices are usually selected such that after issuance the holder bears all risk of a decrease in common stock price, does not benefit from any increase in the common stock price until an upper threshold is reached and thereafter shares a portion of the increase with the issuer. Inducing investors to accept this payoff function requires additional payments by the issuer during the life of the forward purchase contract, which are typically made quarterly. Quarterly payments increase the attractiveness of the security to potential equity investors because they replicate the cash flows associated with commonly owned equity securities (e.g., common or preferred stock).

Unit structured mandatory convertible securities of the type described above may or may not be designed so that the interest payments on the fixed income security portion of the unit are tax deductible. To achieve tax-deductibility, the fixed income security is generally designed to mature at least two years after the settlement of the forward purchase contract. This separation is necessary because tax rules generally disallow deductions for debt that is repaid at maturity in equity and will even integrate separate transactions that occur roughly contemporaneously if the combined transactions would effectively have the economic effect of repaying debt with equity. If the forward contract and the fixed income security matured at or near the same point in time, the two components might be integrated for tax purposes. This possibility arises because the amount the holder is obligated by the forward purchase contract to pay the issuer (in exchange for common stock) typically matches the amount the issuer is obligated by the fixed income security to repay the holder. As a result, the economic effect is that debt (the fixed income security) has been repaid with equity since the payments on the forward purchase contract and the fixed income security offset each other and the holder is left with common stock. The two-year difference in settlement and maturity dates prevents this integration since the settlement and maturity no longer occur contemporaneously and the economic effect is different (for instance, the issuer of the fixed income security still owes the holder its full principal amount regardless of the settlement of the forward purchase contract).

Even when mandatory convertible units (e.g., premium equity participating securities or PEPS^{SM}) are structured to achieve tax-deductions on the interest payments made on the fixed income security, the additional quarterly payments made by the issuer to induce holders to accept the payoff function on the forward purchase contract are not tax deductible. As a result, a firm that issues tax deductible unit structured mandatory convertible securities only achieves the tax deduction on a portion of the total payments it makes to holders during the life of the security.

Accordingly, making more of the payments on tax-deductible unit structured mandatory convertible securities as interest on the fixed income security rather than as non-deductible payments on the forward purchase contract may have significant financial implications for issuers. However, changing the fundamental economics of the transaction achieved by the holders could adversely affect their interest in these securities. Therefore, transaction structures for increasing the tax-deductible portion of these securities without changing the holders' economics are needed.

### SUMMARY OF THE INVENTION

In a general respect, the present invention is directed to a financial unit. According to various embodiments, the unit includes a fixed income security and a forward purchase contract, wherein the fixed income security and the forward purchase contract are separable. The fixed income security may include a maturity date, a principal amount and an interest amount. The forward purchase contract may obligate a holder of the forward purchase contract to purchase a quantity of equity securities of an issuer of the unit for a price equal to the principal amount of the fixed income security no later than a settlement date specified in the forward purchase contract. In addition, the forward purchase contract may further obligate the issuer of the unit to pay a purchaser of the unit a forward purchase contract payment at issuance of the unit. Additionally, the forward purchase contract may obligate the issuer of the unit to pay one or more additional forward purchase contract adjustment payments during the course of the forward purchase contract to the holder of the forward purchase contract.

Implementations according to other embodiments may include the maturity date of the fixed income security being at least two years after the specified settlement date of the forward purchase contract. In addition, the fixed income security may be issued by the issuer of the unit, a subsidiary of the issuer of the unit, or a trust. Further, the fixed income security may be, for example, a note, a bond or a trust-preferred security. The equity security may be, e.g., common stock.

In another general respect, the present invention is directed to a method. According to various embodiments, the method includes issuing a unit, the unit including a fixed income security and a forward purchase contract, which are separable. In addition, the method includes paying at issuance, by a purchaser of the unit, an amount equal to the principal amount of the fixed income security in exchange for purchase of the unit. Further, the method includes paying at issuance, by an issuer of the unit, a forward purchase contract payment to the purchaser of the unit.

In addition, according to various embodiments, the method may include paying interest payments on the fixed income security and forward purchase contract adjustment payments to the purchaser after issuance of the unit and prior to a settlement date specified in the forward purchase contract. Additionally, the method may include at or before the settlement date, the purchaser of the unit purchasing a quantity of equity securities of the issuer of the unit for a price equal to the principal amount of the fixed income security.

Embodiments of the unit allow the issuer to realize greater tax advantages than with conventional premium equity participating securities (PEPS). This is because, for a given net transaction price for the unit, the principal amount of the fixed income security may be greater with embodiments of the present invention than with conventional PEPS. As a result, the periodic interest payments on the fixed income security may be greater than with conventional PEPS, meaning that greater tax deductions may be realized (interest paid on fixed income securities is generally tax deductible under current U.S. tax law). The result, according to various embodiments, is to increase the absolute amount of tax deductions taken and the relative proportion of the total payments made to the holder of the unit that are tax deductible.

These and other benefits will be apparent from the detailed description to follow.

### DESCRIPTION OF THE FIGURES

Embodiments of the present invention will be described by way of example in conjunction with the following figures, wherein:

FIGS. 1-7 are diagrams illustrating various features of a transaction structure according to various embodiments of the present invention;

FIG. 8 is a diagram illustrating a method according to various embodiments of the present invention; and

FIG. 9 is a diagram illustrating a system according to various embodiments of the present invention.

### DETAILED DESCRIPTION OF THE INVENTION

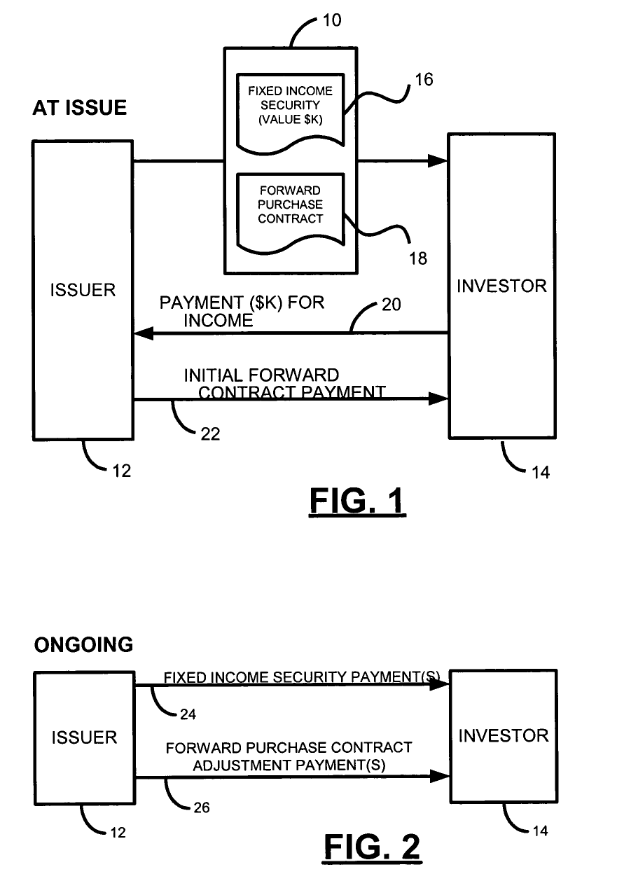

With reference to FIGS. 1-3, the present invention is directed, according to various embodiments, to a financial unit 10 that may be issued from an issuer 12 to an investor 14. The unit 10 may be, for example, a tax-deductible unit structured mandatory convertible security. Only one investor 14 is shown in FIGS. 1-3 for convenience, although it should be recognized that the issuer 12 may issue units 10 to a number of investors. In addition, the issuer 12 may issue multiple units 10 to a single investor 14.

The unit 10 may include two instruments: a fixed income security 16 and a forward purchase contract 18. The fixed income security 16 may be any type of fixed income security, such as, for example, a note, a bond, a trust-preferred security, etc., that provides for periodic interest payments from the issuer 12 to the holder (e.g., investor 14) until maturity of the fixed income security 16 and repayment of the principal amount of the fixed income security 16 at maturity. The forward purchase contract 18 may include terms that require the holder (e.g., investor 14) to purchase a quantity of stock (e.g., common stock) from the issuer 12 at settlement of the forward purchase contract 18. Settlement of the forward purchase contract 18 may occur at or before the settlement date specified in the forward purchase contract 18. The forward purchase contract 18 may also include terms that require the issuer 12 to make an initial forward contract payment 22 and may also require additional periodic forward contract payments 26 to the holder (e.g., investor 14) until settlement of the forward purchase contract 18. The term of the forward purchase contract 18 may be less than the maturity term of the fixed income security 16 such as, for example, two to five years less than the maturity term of the fixed income security 16. In addition, the fixed income security 16 may be pledged by the investor 14 as security to cover (collateralize) the investor's obligations under the forward purchase contract 18.

The fixed income security 16 and the forward purchase contract 18 may be separable. For example, the investor 14, after buying the unit 10 at issue, may sell or otherwise transfer ownership of one or both of the instruments 16, 18, in which case the corresponding obligations associated with the instruments would be owed to and owed by, respectively, the new holders. For convenience, therefore, the investor 14 will be assumed to be the holder of the unit 10 in the description to follow unless a distinction is noted.

As shown in FIG. 1, at the time of issue of the unit 10, the investor 14 may make a payment 20 to the issuer 12 of $K, equal to the principal amount of the fixed income security 16. In addition, at the time of issue the issuer 12 may make a one-time cash payment 22 to the investor 14 of $L for the forward purchase contract 18. The amount of this “forward purchase contract payment” (i.e., $L) may be specified in the forward purchase contract 18. Thus, at issue the issuer 12 may receive a net payment of $K-L. In turn, the investor 14 may make a net payout of $K-L in exchange for the unit 10.

As shown in FIG. 2, throughout the term of forward purchase contract 18, the issuer 12 may make payments 24 of the interest on the fixed income security 16 to the investor 14. In addition, as shown in FIG. 2, the issuer 12 may make forward purchase contract adjustment payments 26, if necessary, to the investor 14, described in more detail below.

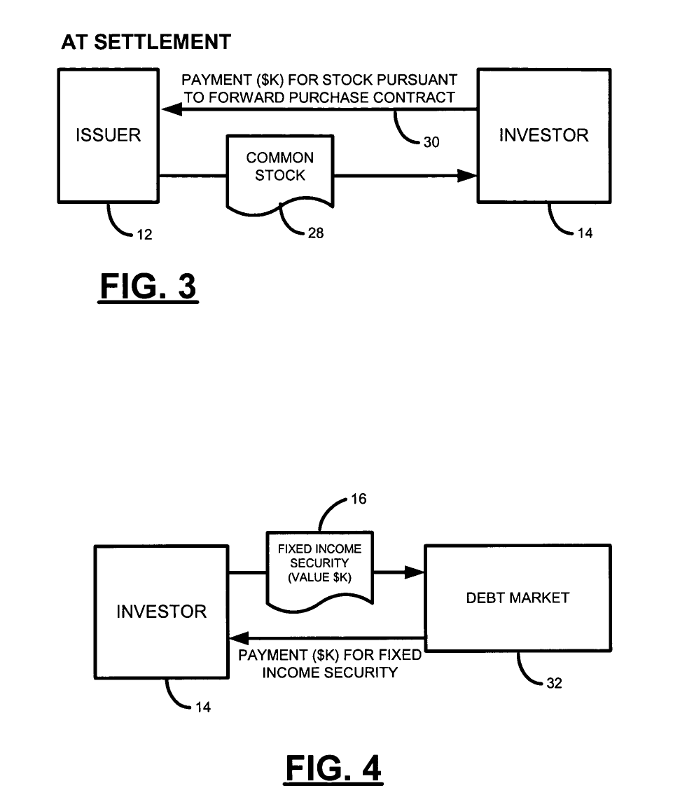

At settlement, as shown in FIG. 3, the issuer 12 may sell a quantity of equity securities such as, for example, common stock 28, to the investor 14 pursuant to the forward purchase contract 18 in exchange for a payment 30 of $K (equal to the principal amount of the fixed income security 16). The issuer 12 of the unit 10 may be the issuer of the common stock purchased by the investor 14, although according to other embodiments the issuer of the common stock purchased by the investor 14 may be a different entity than the issuer 12 of the unit 10. This may be the case where, for example, the issuer 12 of the unit 10 owns stock of another (second) company and it is the stock of the second company that is purchased by the investor 14 at settlement.

The effect of the foregoing, according to various embodiments, is to increase the absolute amount of tax deductions taken and the relative proportion of the total payments made to the investor 14 that are tax deductible in comparison with conventional premium equity participating securities (PEPS). Neither the forward purchase contract adjustment payments 26 nor the quarterly forward purchase contract adjustment payments in conventional PEPS are tax deductible according to current U.S. tax law. Thus, for a conventional PEPS with a stated value of $K-L, the issuer receives less tax deductions than with embodiments of the present invention. This is because the fixed income security 16 of the present invention may have a greater stated amount ($K) than conventional PEPS ($K−L) for a given net valued transaction, and the one-time cash payment of $L at issue to the investor 14 (see FIG. 1) may match the increase in the stated amount of the fixed income security 16 and the increased price paid by the investor 14 at settlement for the common stock (see element 30, FIG. 3) relative to a conventional PEPS. The result is that with embodiments of the present inventions, the issuer 12 may achieve an increase in the absolute amount of tax deductions taken and the relative portion of the total payments made to the investor 14 that are tax deductible.

Consider the following example. Suppose an issuer, in a conventional PEPS, issues a unit with a price of $25.00. Suppose further that the common stock price for the issuer at the time of the issue is $46.50 and that the straight debt rate is 3.05% with a forward fee of 3.95%. Thus, the yield on the conventional PEPS is 7.00% (computed as 3.05% debt rate plus 3.95% forward fee). Further assume that the premium is 20%, which corresponds to a conversion ratio of 0.45 to 0.54 shares per PEPS unit. With these assumptions, for a conventional PEPS the issuer would pay $0.76 in interest payments per unit to the investor (computed as $25 unit price times 3.05% debt rate) and $0.99 in forward purchase contract payments 26 per unit to the investor (computed as $25 unit price times 3.95% forward fee) periodically throughout the term of the forward purchase contract, for a total periodic payment of $1.75. At settlement with a conventional PEPS structure, the investor would pay $25 to the issuer in exchange for 0.45 to 0.54 (the conversion ratio) shares of common stock per PEPS unit.

In contrast, according to various embodiments of the present invention, with the same set of assumptions, the issuer 12 may issue the unit 10 with a stated amount of $35, which is $10 higher than for a conventional PEPS in this example. Thus, L=$10 in this example. In exchange, therefore, at issue the investor 14 may receive a fixed income security 16 with a stated amount of $35 and a $10 initial forward purchase contract payment 22. Thus, the net cash received by the issuer 10 at issue ($25) is the same as in a conventional PEPS, but the stated amount of the fixed income security 16 is greater (by L=$10 in this example) than in a conventional PEPS. Thus, going forward, the issuer 10 may make periodic interest payments to the investor 14 in an amount of $1.07 per unit 20 in this example (computed as $35 unit price times 3.05% debt rate). To achieve the same $1.75 combined periodic payment as for the conventional PEPS example described above, the issuer 12 may also pay the investor 14 a periodic $0.68 forward purchase contract adjustment payment 26 per unit (computed as $1.75 minus $1.07 for the interest payment).

The difference, however, is that because the principal amount of the fixed income security 16 has increased (to $35 from $25 in this example), the corresponding interest payments are greater ($1.07 versus $0.76 in this example) with embodiments of the present invention when compared to a conventional PEPS. As a result, since the total amount of the interest payment 24 has increased, the amount of the forward purchase contract adjustment payments 26 is reduced (to $0.68 from $0.99 in this example). Thus, with embodiments of the present invention, the issuer 12 may achieve greater tax deductions when issuing the units 10 than would occur with a conventional PEPS because of the increased tax-deductible interest payments (the interest payments are generally tax deductible under current U.S. tax law). At settlement, the investor 14 may pay $35 in this example (the stated amount of the fixed income security 16) for the same 0.45 to 0.54 shares per unit 10 as in conventional PEPS.

Thus, for the issuer 12, the effect of embodiments of the present invention is to increase the absolute amount of tax deductions and the relative proportion of the total payments made to the investor 14 that are tax deductible. That is, the issuer 12 may pay the same total amount to the investor 14 in aggregate interest payments plus forward purchase contract payments until the settlement date for the forward purchase contract 18 as in conventional PEPS ($1.75 in the above example). However, because the principal amount of the fixed income security 16 has increased, the amount of the interest payments has correspondingly increased. The one-time forward purchase contract payment 22 of $L ($10 in the above example) at issuance to the investor 14 by the issuer 12 may compensate the investor 14 for the higher purchase price for the same quantity of common stock 30 at the settlement date ($35 versus $25 in the above example), meaning that the total amount of periodic payments for the units 10 as a whole remains the same. As a result, since the total amount is the same and the interest payments have increased, the amount of the periodic forward purchase contract payments by the issuer decreases. Thus, the issuer 12 may achieve greater tax deductions when issuing the units 10 than would occur with conventional PEPS.

For the investor 14, embodiments of the present invention may preserve the transaction economics of a conventional PEPS. At issuance and until the forward purchase contract settlement date, taking into account the one-time forward purchase contract payment 22, the investor 14 may hold a fixed income security 16, receive interest payments 24 and forward purchase contract payments 22, 26, and remain obligated to purchase common stock 28. When the settlement date occurs (see FIG. 3), the investor 14 may pay a higher price to purchase the same number of shares of the issuer's common stock 28 as in a conventional PEPS ($35 versus $25 in the above example), but the price difference may be exactly offset by the one-time forward purchase contract payment the investor 14 received when the unit 10 was issued. The fixed income security 16 may be repaid by the issuer 12 at maturity exactly as it ordinarily would be repaid in a conventional PEPS. The net result, therefore, may be identical investor and issuer economic effects between embodiments of the present invention and a conventional PEPS, but enhanced tax deductions for the issuer 12 with embodiments of the present invention.

As mentioned previously, the fixed income security 16 and the forward purchase contract 18 of the unit 10 may be separable. That is, for example, the investor 14 may resell one or both the instruments after issuance. For example, as shown in FIG. 4, the investor 14 may resell the fixed income security 16 to a buyer in the debt market 32. The investor 14 may, for example, resell the fixed income security 16 at or near the settlement date of the forward purchase contract 18. This may be done in order that the investor 14 may raise the necessary proceeds to satisfy the investor's obligations to purchase common stock 28 from the issuer 12 under the forward purchase contract 18. The issuer 12 may be obligated to pay a remarketing agent a fee to facilitate the resale, or such fee may be paid out of the excess, if any, of the proceeds of the sale over the stated amount of the unit 10, in either case pursuant to the transaction documents. The terms, including the interest rate, on the fixed income security 16 may be changed to facilitate the resale at the necessary price. Where the fixed income security 16 is pledged as security to cover the investor's obligations under the forward purchase contract 18, if the investor 14 resells the fixed income security 16 prior to settlement the investor 14 may secure its obligations by delivering other assets, such as, for example, U.S. Treasury notes, to the issuer 12. In some cases, for example, if the investor 14 fails to resell the fixed income security 16 to a new investor at or near settlement or if the investor 14 does not perform his obligations under the forward purchase contract 18, the issuer 12 may, for example, dispose of the fixed income security 16 by exercising its rights as a secured party to satisfy the forward purchase contract 18 or the investor 14 may be permitted to put the fixed income security 16 to the issuer 12 for the stated value of the unit 10.

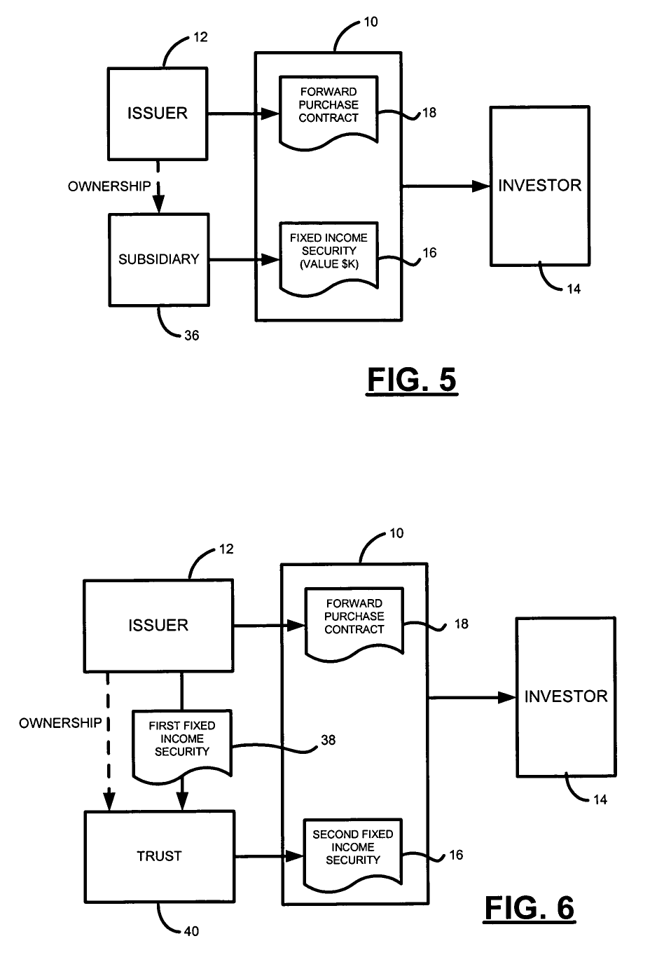

According to other embodiments, as illustrated in FIG. 5, the fixed income security 16 may be issued by a subsidiary 36 of the issuer 12. The economic and tax effects of the structure of FIG. 5 may be the same as described above for FIGS. 1-3 and the only structural difference may be the entity that issues the fixed income security, viz., the subsidiary 36 in FIG. 5 versus the issuer 10 in FIGS. 1-3. Implementations of the sort shown in FIG. 5 may also include a guaranty by the forward purchase contract issuer 12 of the obligations of its subsidiary 36 to pay the principal and interest on the fixed income security 16.

According to another embodiment, as illustrated in FIG. 6, the issuer 12 may issue a first fixed income security 38, such as for example, a note or a bond, to a trust 40. The issuer 12 may have an ownership interest in the trust 40. The trust 40 may then issue a fixed income security such as, for example, a trust-preferred security, that becomes the fixed income security 16 of the unit 10 purchased by the investor 14. A trust-preferred security is a security issued by a trust that may possess characteristics of both equity and debt issues. Again, like the structure of FIG. 5, the economic and tax effects of the structure of FIG. 6 may be the same as described above for FIGS. 1-3 and the only structural difference may be the entity that issues the fixed income security, viz., the trust 40 in FIG. 6 versus the issuer 10 in FIGS. 1-3. In addition, as before, the issuer 12 may guarantee the payment obligations of the trust 40 to pay the principal and interest on the fixed income security 16.

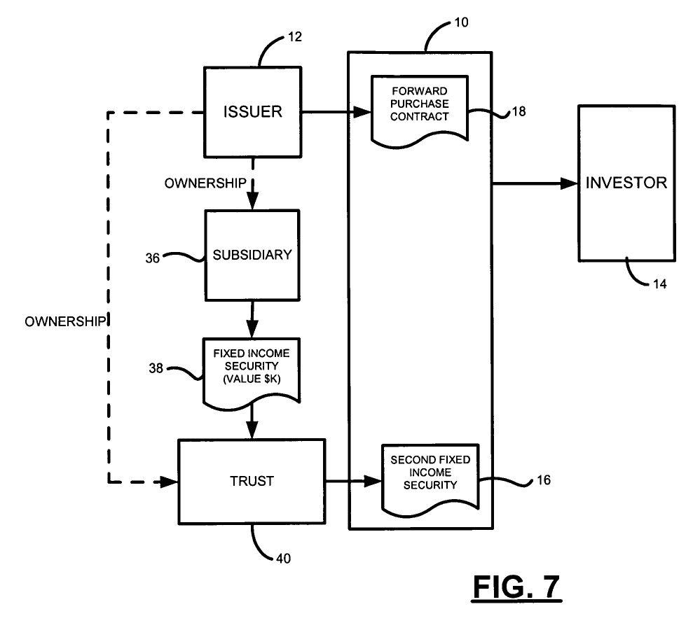

In addition, according to other embodiments, the structures of FIGS. 5 and 6 may be combined, as shown in FIG. 7. That is, for example, the subsidiary 36 of the issuer 12 may issue the first fixed income security 38 that is purchased by the trust 40. The trust 40 may then sell the second fixed income security 16 as part of the unit 10 to the investor 14. Again, the issuer 12 may guaranty the payment obligations of the subsidiary 36 and the trust 40 for the respective first and second fixed income securities 38, 16.

According to other various embodiments, the fixed income security 16 may be issued by a parent of the issuer 12 of the unit 10. That is, for example, the fixed income security 16 may be issued by an entity having an ownership interest in the issuer 12.

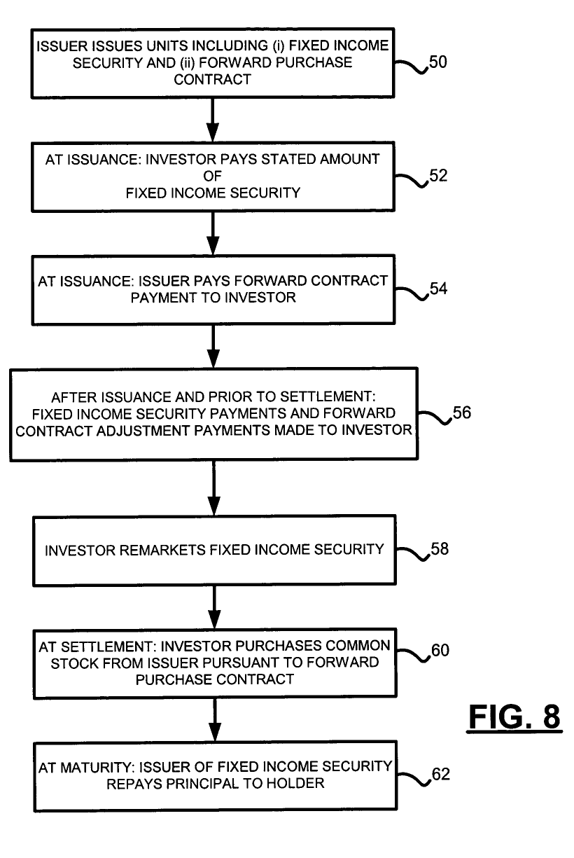

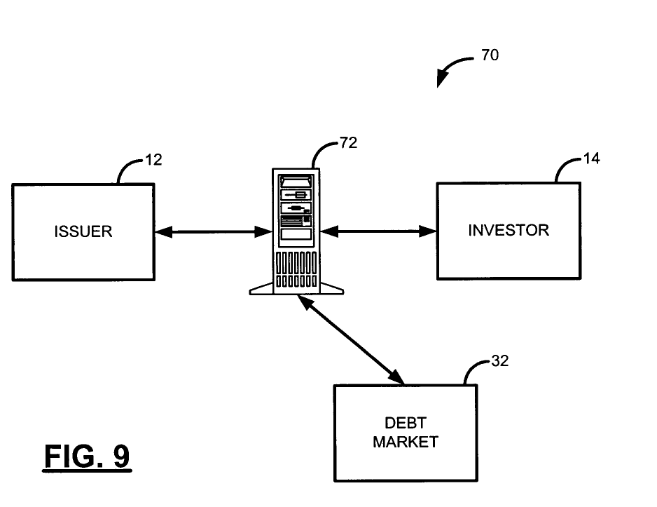

The present invention is also directed to a method, for which a flowchart according to various embodiments is shown in FIG. 8. The method may include, according to various embodiments, the issuer 12 issuing the units 10 that include the fixed income security 16 and the forward purchase contract 18, as described above, at block 50. At block 52, at the time of issuance, the purchaser of a unit 10 (e.g., the investor 14) may pay the stated amount (i.e., the principal) of the fixed income security 16. As explained above, the fixed income security 16 may be issued by, for example, the issuer 12, a subsidiary 36 of the issuer 12, or a trust 40. At block 54, also at issuance, the issuer 12 may pay the investor 14, as purchaser of a unit 10, the initial forward purchase contract payment 22.

At block 56, after issuance and prior to settlement, the investor 14 may receive the periodic interest payments on the fixed income security 16 as well as the forward purchase contract adjustment payments 26 (see FIG. 2).

At block 58, the investor 14 may remarket the fixed income security 16. That is, as explained previously in connection with FIG. 4, the investor 14 may resell the fixed income security 16 to a new investor in the debt market 32. This step may be performed before the settlement date of the forward purchase contract 18 in order that the investor 14 may have sufficient proceeds to perform its obligations to purchase common stock 28 from the issuer 12 under the forward purchase contract 18. At block 60, at settlement, pursuant to the forward purchase contract 18, the investor 14 may pay the issuer 12 for a quantity of common stock 28 of the issuer 12 (see FIG. 3). At block 62, at the maturity date of the fixed income security 16, the issuer of the fixed income security (e.g., the issuer 12, the subsidiary 36 or the trust 40) may repay the holder of the fixed income security 16 (e.g., the buyer from the debt market 32 at block 58) the principal amount of the fixed income security 16.

In addition, the step of remarketing the fixed income security 16 may be performed automatically, as shown in FIG. 9. FIG. 9 is a diagram of a system 70 for implementing features of the above-described methods according to various embodiments. The system 70 may include, as shown in FIG. 9, a computing device 72 in communication with accounts of the issuer 12 and the investor 14. The computing device 72 may also be in communication with buyers in the debt market 32.

According to one embodiment, at or near the settlement date, the computing device 72 may sell, on behalf of the investor 14, the fixed income security 16 to a new investor in the debt market 32. The computing device 72 may then, with the proceeds from the sale of the fixed income security 16, direct payment to the issuer 12 commensurate with the investor's payment obligations under the forward purchase contract 18 by electronically depositing the appropriate funds ($K) into an account of the issuer 12. Any remaining proceeds from the sale of the fixed income security 16 to the debt market 32 may be electronically deposited in an account of the investor 14 or used to pay the fee of the remarketing agent (and hence deposited in an account of the remarketing agent). In FIG. 9 the computing device 72 is shown as a single unit for purposes of convenience, but it should be recognized that the computing device 72 may comprise a number of distributed computing devices, inside and/or outside the same administrative domain.

In order to sell the fixed income security 16 in the debt market 32 and electronically deposit finds in accounts of the issuer 12 and/or investor 14, the computing device 72 may execute a series of instructions. The instructions may be software code to be executed by the computing device 72. The software code may be stored as a series of instructions or commands on a computer readable medium, such as a random access memory (RAM), a read only memory (ROM), a magnetic medium such as a hard-drive or a floppy disk, or an optical medium such as a CD-ROM, and may be written in any suitable computer language such as, for example, Java, C, or C++ using, for example, conventional or object-oriented techniques.

According to various embodiments, a separate entity such as, for example, an investment bank, may play a role in the transaction. For example, the investment bank may price the unit 10 for the offering. The investment bank may price the unit 10 using, for example, pricing models, data regarding recent similar deals, feedback from investors, etc. In addition, the investment bank may market the unit 10 to potential investors, underwrite the issuance of the unit 10, and arrange the transaction structure. Additionally, the investment bank may structure the unit 10, such as determining which entity issues the various instruments of the unit 10 and other features of the instruments.

While several embodiments of the present invention have been described herein, it should be apparent that various modifications, alterations and adaptations to those embodiments may occur to persons skilled in the art. For example, the steps illustrated in FIG. 8 may be performed in various orders. It is therefore intended to cover all such modifications, alterations and adaptations without departing from the scope and spirit of the present invention as defined by the appended claims.

1. A unit having a stated amount, comprising:
a fixed income security having a maturity date, a principal amount and an interest rate; and
a forward purchase contract, wherein the fixed income security and the forward purchase contract are separable, wherein the forward purchase contract obligates a holder of the forward purchase contract to purchase a quantity of equity securities from an issuer of the unit for a price equal to the stated amount of the unit no later than a settlement date specified in the forward purchase contract, and wherein the forward purchase contract further obligates the issuer of the unit to pay a purchaser of the unit a forward purchase contract payment at issuance of the unit.

2. The unit of claim 1, wherein the maturity date of the fixed income security is at least two years after the specified settlement date of the forward purchase contract.

3. The unit of claim 1, wherein the fixed income security is issued by the issuer of the unit.

4. The unit of claim 1, wherein the fixed income security is issued by a subsidiary of the issuer of the unit.

5. The unit of claim 1, wherein the fixed income security is issued by a trust, wherein the issuer has an ownership interest in the trust.

6. The unit of claim 5, wherein the fixed income security is a trust-preferred security.

7. The unit of claim 1, wherein the fixed income security is a bond.

8. The unit of claim 1, wherein the issuer of the unit is not the issuer of the equity securities.

9. The unit of claim 1, wherein the fixed income security is issued by a parent of the issuer of the unit.

10. A method, comprising:
issuing a unit having a stated amount, the unit including a fixed income security and a forward purchase contract, wherein the fixed income security and the forward purchase contract are separable;
paying at issuance, by a purchaser of the unit, a principal amount of the fixed income security in exchange for purchase of the unit;
paying at issuance, by an issuer of the unit, a forward purchase contract payment to the purchaser of the unit.

11. The method of claim 1, wherein the maturity date of the fixed income security of the unit is at least two years after the specified settlement date of the forward purchase contract.

12. The method of claim 10, further comprising paying interest fee payments on the fixed income security and forward purchase contract adjustment payments to the purchaser after issuance of the unit and prior settlement of the forward purchase contract.

13. The method of claim 12, further comprising, at settlement, the purchaser of the unit purchasing a quantity of equity securities from the issuer of the unit for a price equal to the stated amount of the unit.

14. The method of claim 13, wherein the purchaser of the unit purchasing a quantity of equity securities of the issuer includes the purchaser purchasing a quantity of common stock of the issuer.

15. The method of claim 13, further comprising the purchaser reselling the fixed income security.

16. The method of claim 15, wherein reselling the fixed income security includes the purchaser reselling the fixed income security prior to the settlement date.

17. The method of claim 16, wherein the purchaser of the unit purchasing a quantity of equity securities of the issuer includes the purchaser paying the issuer with proceeds from resale of the fixed income security.

18. The method of claim 10, wherein the fixed income security is a bond.

19. The method of claim 13, further comprising a subsidiary of the issuer of the unit issuing the fixed income security.

20. The method of claim 19, further comprising the issuer of the unit guarantying payment obligations of the subsidiary.

21. The method of claim 13, further comprising a trust issuing the fixed income security, wherein the issuer of the unit has an ownership interest in the trust.

22. The method of claim 21, further comprising the issuer of the unit guarantying payment obligations of the trust.

23. The method of claim 21, wherein the fixed income security includes a trust-preferred security.

24. The method of claim 21, further comprising the trust purchasing a second fixed income security.

25. The method of claim 21, further comprising the trust purchasing a second fixed income security issued by a subsidiary of the issuer of the unit.

26. The method of claim 13, further comprising a parent of the issuer of the unit issuing the fixed income security.

27. A system, comprising a computing device for reselling a fixed income security on behalf of an investor, wherein the fixed income security was issued as part of a unit further including a forward purchase contract, wherein the forward purchase contract obligates a holder of the forward purchase contract to purchase a quantity of equity securities from an issuer of the unit for a price equal to a stated amount of the unit no later than a settlement date specified in the forward purchase contract, and wherein the forward purchase contract further obligates the issuer of the unit to pay a purchaser of the unit a forward purchase contract payment at issuance of the unit.

28. The system of claim 27, wherein the computing device is further for electronically depositing at least a portion of the proceeds from the resale of the fixed income security in an account of the issuer of the unit.

29. The system of claim 28, wherein the computing device is further for electronically depositing a remaining portion of the proceeds from the resale of the fixed income security in an account of at least one of the investor and a remarketing agent.

30. A computer readable medium, having stored thereon instructions which, when executed by a computing device, cause the computing device to resell a fixed income security on behalf of an investor, wherein the fixed income security was issued as part of a unit further including a forward purchase contract, wherein the forward purchase contract obligates a holder of the forward purchase contract to purchase a quantity of equity securities from an issuer of the unit for a price equal to a stated amount of the unit no later than a settlement date specified in the forward purchase contract, and wherein the forward purchase contract further obligates the issuer of the unit to pay a purchaser of the unit a forward purchase contract payment at issuance of the unit.

31. The computer readable medium of claim 30, having further stored thereon instructions which, when executed by the computing device, cause the computing device to electronically deposit at least a portion of the proceeds from the resale of the fixed income security in an account of the issuer of the unit.

32. The computer readable medium of claim 31, having further stored thereon instructions which, when executed by the computing device, cause the computing device to electronically deposit a remaining portion of the proceeds from the resale of the fixed income security in an account of at least one of the investor and a remarketing agent.

33. A method, comprising a pricing a unit for sale to potential investors, wherein the unit includes:
a fixed income security having a maturity date, a principal amount and an interest rate; and
a forward purchase contract, wherein the fixed income security and the forward purchase contract are separable, wherein the forward purchase contract obligates a holder of the forward purchase contract to purchase a quantity of equity securities from an issuer of the unit for a price equal to a stated amount of the unit no later than a settlement date specified in the forward purchase contract, and wherein the forward purchase contract further obligates the issuer of the unit to pay a purchaser of the unit a forward purchase contract payment at issuance of the unit.
